(19) United States
(12) Patent Application Publication
(10) Pub. No.: US 2021/0075177 A1
(43) Pub. Date: Mar. 11, 2021

(54) TOOL CHANGER, MACHINE TOOL, AND METHOD FOR CHANGING A TOOL

(71) Applicant: SCHLEUNIGER AG, Thun (CH)

(72) Inventors: Roland KAMPMANN, Witten (DE); Michal MIARKA, Krakow (PL)

(21) Appl. No.: 17/050,018

(22) PCT Filed: Apr. 24, 2018
(86) PCT No.: PCT/IB2018/052859

§ 371 Date: Oct. 23, 2020

(51) Int. Cl. H01R 43/058; H01R 43/055

(52) U.S. Cl. CPC H01R 43/058; H01R 43/055

(57) ABSTRACT

A tool changer (1, 1′) for a machine tool, comprising a tool table (10) having at least two tool spaces (11, 11′), in particular for the detachable accommodation of a tool (50, 50′). The tool changer (1, 1′) has a pivot arm (20) that can be fastened to the machine tool for pivoting the tool table (10).

The present application concerns a tool changer, a machine tool, and also a method for the changing of a tool according to the independent claims.

Various machine tools are of known art from the prior art. DE 20 2006 020 927 U1 discloses a machine tool, namely a crimping press for various crimping and pressing processes. Various crimping tools can be introduced into the crimping press of DE 20 206 020 927 U1; in other words, the crimping press of DE 20 206 020 927 U1 can be converted to serve a plurality of different crimping processes. Here the crimping tool as well as an associated contact coil and an associated paper strip winder must be replaced. This process is described in detail in the above-cited document. In order to simplify this process, that is to say, the conversion, it is proposed to design these cited elements as a separate module. Although the conversion process could be simplified with the device from DE 20 206 020 927 U1, the replacement of the respective modules still requires a not inconsiderable effort.

From EP 3 240 123 A1 a crimping machine with a crimping tool replacement device has also become of known art. The crimping tool replacement device of EP 3 240 123 A1 is designed such that it has two replacement stations, each for holding a crimping tool. From these replacement stations, the respective crimping tools can be moved into a processing position along a first direction of movement. An appropriate guidance device is provided for the movement of the crimping tool. The disadvantage of this device is that a full conversion of the machine is not possible, only an alternating use of the tools arranged in the crimping tool replacement device is possible. The crimping tool replacement device of EP 3 240 123 A1 is also complicated in its production, and also complicated in the alignment of the individual elements relative to each other.

It is the object of the invention to overcome one or a plurality of the disadvantages of the prior art. In particular, a tool changer for a machine tool and/or a method for the changing of a tool of a machine tool is to be provided, which simplifies the change of a tool, in particular a crimping tool. One or a plurality of the disadvantages of the prior art are preferably overcome by a machine tool comprising such a tool changer.

This object is achieved by means of the devices and methods defined in the independent claims. Further forms of embodiment ensue from the dependent claims.

An inventive tool changer for a machine tool, preferably for a cabling machine tool, and in particular for a crimping press, comprises a tool table with at least two tool stations for, in particular, the detachable accommodation of a tool, in particular a crimping tool. The tool table preferably comprises precisely two tool stations. The tool changer has a pivot arm that can be fixed to the machine tool for the pivoting of the tool table.

This enables the precise positioning of the tool changer on a machine tool, and thus the precise changeover of a corresponding tool, which is arranged on the tool changer.

The retractable holder enables the tool to be simply replaced.

The pivot arm also enables the movement of the tool table along a defined path, preferably a circular path. The tool table of the tool changer can thus assume at least two positions defined along a movement path.

The tool table is preferably arranged on the pivot arm such that it can rotate.

This enables the rotation of the tool table relative to the pivot arm. By means of the rotation of the tool table relative to the pivot arm, it is possible to adjust one or a plurality of the positions of the tool stations relative to the pivot arm. That is to say, if the tool changer has, for example, two tool stations, either one of the two tool stations can be rotated to a specific position relative to the pivot arm simply by rotating the tool table.

For this purpose, the tool table is preferably arranged on a pivot pin, which forms the axis of rotation of the tool table, which is arranged on the pivot arm. The tool stations are preferably arranged centrosymmetrically around the pivot pin, or around the axis of rotation.

The tool table can have one contact coil station per tool station for the accommodation of a contact coil.

This enables the conversion of the tool independently of any other device, as well as an individual/independent operation of the respective tool, in the present case in particular a crimping tool.

In addition, provision can be made for the tool table to have a paper strip winder per tool station for the winding on of paper strips.

This enables the conversion of the tool independently of any other device as well as an individual/independent operation of the respective tool, in the present case in particular a crimping tool.

Here, provision can be made for each paper strip winder to have a separate drive. Alternatively, it is also possible for none of the paper strip winders to have a drive; instead a separate drive is provided. The separate drive can be designed, for example, as a component of the machine tool. The separate drive can in particular be designed and arranged such that this engages with a corresponding device of the paper winder, as soon as the tool changer has an appropriate position relative to the machine tool, in particular is pivoted into an operating position.

Provision can also be made for the tool table to have a guide plate per tool station for the accommodation and guidance of the contact strips, that is to say, in particular, it provides a contact strip guide.

The guide plate is preferably designed such that in the operating position of the tool changer this guides a contact strip around the pivot arm.

This enables the simple insertion and guidance of the contact strip, as well as the simple conversion and/or an individual/independent operation of the respective tool, in the present case in particular a crimping tool.

In addition, provision can be made for the tool changer to have per tool station on the tool table one protective plate, in particular a sheet metal tub, for the protection of the contact coils. Here the protective plate can be arranged on the respective contact coil station.

By virtue of the protective plate, contact damage, that is to say, damage to the crimping contacts, can be reliably prevented. Also, provision can be made for any contact between the contact strips and the protective plate to be detected, such that when there is contact between the contact strips and the protective plate the paper winder is controlled. This enables the contact strip to be unwound by the paper winder to an extent such that a feed mechanism of the crimping tool requires only a minimum tensile force to pull a contact into the crimping tool.

In an embodiment of the tool changer with two or more tool stations, and correspondingly, the same number of contact coil stations, and/or paper strip winders, and/or guide plates, and/or protective plates, these are preferably arranged centrosymmetrically around an axis of rotation, and in the present case in particular around the pivot pin, of the tool table.

In a preferred form of embodiment, each tool station is assigned a quick-release device for the attachment of the tool.

This enables the simple and quick attachment or release of a tool at the tool station and thus on the tool table.

For this purpose the quick-release device can have a retaining claw; the quick-release device preferably has an actuation lever for the actuation of the retaining claw. The retaining claw can have at least one spring for the pre-loading of the retaining claw.

With a retaining claw, the reliable attachment of a tool to the tool table and in particular to the tool station is enabled. The actuation lever enables the simple actuation, that is to say, the simple release and attachment of the retaining claw. A spring for the pre-loading of the retaining claw and/or the actuation lever secures it against inadvertent opening or release.

The lever can be operated manually. However, it is also conceivable that the lever is pneumatically or hydraulically actuated, or that the retaining claw itself has a hydraulic or pneumatic actuation device.

In a preferred form of embodiment, the tool changer on the tool table has a first end stop. This operates together with a first complementary part on the pivot arm such that the tool table assumes a first position defined relative to the pivot arm. The tool changer can have a second end stop, in particular on the tool table, which operates with the first complementary part, or a second complementary part, on the pivot arm, such that the tool table assumes a second position defined relative to the pivot arm. The first complementary part and the second complementary part are preferably formed as one piece.

This enables the provision of a first and/or a second position of the tool table, which is defined relative to the pivot arm. Irrespective of the position of the pivot arm, the position of the tool table does not alter relative to the pivot arm.

The end stops are preferably arranged such that the tool table can assume a position that can be reversed through 180°.

Here provision can be made for the first and/or the second end stop to be arranged on the pivot pin of the tool table.

The tool changer preferably has a locking device for the detention of the tool table.

This enables the tool table to be secured against inadvertent rotation.

The locking device is preferably arranged on, in particular in, the pivot arm. The detention of the tool table preferably depends on a position of the pivot arm.

An arrangement of the locking device on or in the pivot arm enables a compact embodiment of the locking device.

Here provision can be made for the first and/or second complementary parts, for interaction with the first/or second end stops, to be designed as part of the locking device, and in particular to form a component of the locking device.

This enables the detention function on the one hand and the positioning function on the other to be combined in one component.

The pivot arm can have a mounting base for the attachment of the tool changer to the machine tool. The pivot arm is preferably connected to the mounting base such that it can pivot. For the connection of the pivot arm to the mounting base, a pivot bolt can be provided.

The mounting base enables a simple retrofit or upgrade of an existing machine tool. The pivoting connection of the pivot arm to the mounting socket enables the provision of a simple interface with the machine tool, which can be embodied as a rigid connection, and does not need to serve any further functions. A pivot bolt enables the pivot arm to be simply connected to the mounting base, together with a pivoting of these elements relative to each other.

In a preferred form of embodiment provision can be made for the locking device to interact with the mounting base such that a release of the detention of the tool table depends on an angle of pivot between the mounting base and the pivot arm.

Depending on the position of the pivot arm relative to the machine tool, a rotation of the tool table is thus enabled or prevented. Provision can therefore be made that, for example, in one operating position of the tool changer the rotation of the tool table is prevented, by the pivoting of the tool changer into a changeover position; that is to say, by the pivoting of the pivot arm from the operating position into the changeover position, the locking device is actuated by the mounting base and thus in the changeover position the detention is released, and the rotation of the tool table is only enabled in this changeover position. In other words, provision can be made for the locking device to be actuated by the mounting base such that the detention is released from a certain angle of the pivot arm relative to the mounting base.

For this purpose, the mounting base can have an actuation bolt. The locking device is preferably designed as a push rod, which is arranged on, or in, the pivot arm and interacts with the actuation bolt on the mounting base, and in particular is pushed by the actuation bolt in a linear manner along the pivot arm.

The complementary part, which is preferably arranged on the end face of the locking device, can thereby be pushed from a first position into a second position. In the first position, the complementary part interacts with an end stop on the pivot bolt; in the second position the complementary part releases the end stop, so that the pivot bolt is free to rotate. Correspondingly, the tool table can be rotated relative to the pivot arm.

The pivot arm for the pivoting of the tool table can be pivoted into at least one operating position and one changeover position. The tool changer can have an end position stop for the operating position, and/or for the changeover position.

As described above, by virtue of the provision of an operating position and a changeover position, a precisely defined position relative to the mounting base and thus to the machine tool can be specified. Depending on the position assumed by the pivot arm, only specific manipulations are possible. That is to say, for example, that in the operating position the tool table is secured against an inadvertent rotation, but in a changeover position is free to rotate.

The operating position is the position that corresponds to the position in which the tool changer is in the inward pivoted position, and the machine tool is in operation, or can be set into operation. The changeover position is the position in which the tool changer is pivoted outward, and in particular the tool table can be rotated.

The tool changer can have a position-clamping device for the detention of the pivot arm in at least the operating position, and/or the changeover position.

This enables the pivot arm to be secured in the event of inadvertent pivoting. In particular, provision can be made for the pivot arm in the operating position to be secured, both with respect to a pivot angle, and with respect to an operating height.

Here provision can be made for the position-clamping device to have a holding fixture for the detention of the tool changer in the operating position. Here the holding fixture is preferably arranged, or can be arranged, on the machine tool. Additionally or alternatively, the position-clamping device can have an end position stop for the operating position.

The holding fixture enables the precise detention of the tool changer in terms of position. In particular, both the height of the tool changer, and also a pivot angle of the tool changer, can be specified.

If the holding fixture is arranged on the machine tool, this enables the tool changer to be precisely held on the machine tool. An end stop also enables the precise positioning of the tool changer relative to the machine tool.

The position-clamping device can be manually actuated, or can have pneumatic or hydraulic assistance. A clamping bolt is released against a spring force, preferably by means of a compressed air button. Depending on the machine tool, pneumatic or hydraulic systems are already provided, which facilitates the implementation of an appropriate device.

Another aspect of the present invention relates to a machine tool, in particular a cabling machine tool, preferably a crimping press. The machine tool comprises at least one, preferably two, tool changers. The one or more tool changers are preferably tool changers as described above. The tool changer comprises a pivot arm for the pivoting of a tool table. The pivot arm is arranged on the machine tool such that it can pivot.

This enables the provision of a complete machine tool, whereby the pivotable arrangement of the tool changer enables the precise changeover of an appropriate tool, which is arranged on the tool changer.

The pivotable pivot arm also enables the movement of the tool table along a defined path, preferably a circular path. The tool table of the tool changer can thus occupy at least two defined positions along a movement path.

The machine tool can comprise a protective hood. In addition, a tool table can be arranged on the pivot arm of the tool changer, whereby the tool table has at least two tool stations. In an operating state of the machine tool, at least one tool station is arranged inside the protective hood, and one tool station is arranged outside the protective hood.

Typically, for the operation of the tool, for example with a crimping press, this is lifted off from the tool table and is operatively connected with the crimping press. However, the corresponding contact coils and/or paper winders are still located on the tool table. For the complete setting up of the tool arranged inside the protective hood, this is manually detached from the tool table of the tool changer during the setting up process and then clamped into a mounting of the crimping press. For this purpose, the crimping press is fitted with an appropriate clamping device for the tool. The crimping press is then set up ready for operation.

Correspondingly, before the changeover of the tool by pivoting of the tool changer, it is necessary firstly to release the tool from the clamping device/mounting of the crimping press after the end of operation with the protective hood open, then to reset it onto the tool table of the tool changer, and to clamp it there. The tool changer can then be pivoted outward.

Since one of the tool stations in the operating state of the machine tool is arranged inside the protective hood, a tool assigned to this tool station can be actuated, wherein the second tool, arranged outside the protective hood, remains accessible.

Thus, it is possible to manipulate the second tool during the operation of the machine tool, that is to say, the tool located on the second tool station can be retrofitted. For this purpose, for example, a contact coil located in a contact coil station on the tool table is removed. In addition, a tool located on the corresponding tool station is removed. Here, when using a tool table as described above, a quick-release device can be released. A new contact coil can be arranged at the contact coil station. A new tool can also be arranged at the tool station. These steps are possible without the need for adjustment and/or interruption of the ongoing operation of the machine tool.

As described above, at least one or a plurality of limit switches can be provided on the machine tool. The one or more limit switches are provided for the monitoring at least one of the parameters from the following group: position of the pivot arm, position of the protective hood, position of the tool, status of the position-clamping device, occupation of the tool station.

The status of the machine tool and/or the tool changer can thus be monitored by means of appropriate limit switches. For example, a limit switch can be provided to monitor the position of the pivot arm. For example, if the pivot arm is in a changeover position, that is to say, pivoted outward from the machine tool, the start-up of the machine tool is prevented. If need be, a maintenance or changeover mode can be initiated by monitoring this limit switch, which mode only enables some specific manipulations of the machine tool. All signals of the limit switches can be transferred to an appropriate machine controller, which evaluates the signals and releases or blocks appropriate functions and/or generates error messages that are forwarded to a user or to another controller.

Another aspect of the present invention relates to a method for the changeover of a tool of a machine tool, in particular on a machine tool as described above. In particular, the method relates to the changeover of a tool of a cabling machine tool, preferably a crimping press. The machine tool comprises a tool changer, which comprises a tool table and a pivot arm for the pivoting of the tool table. In particular the machine tool comprises a tool changer as described above. For the changeover of the tool, the tool table is rotated from a first position into a second position. The tool changer is pivoted from an operating position into a changeover position before the rotation of the tool table.

The pivoting of the tool changer enables the movement of a tool located on the tool changer from an operating position into a changeover position. In other words, a tool table can be pivoted outward from the immediate area of influence of the machine tool by the pivoting of the tool changer, thus making the tool changer accessible.

The pivot arm of the tool changer is preferably attached to the machine tool, in particular to a mounting base. This enables the precise and exact pivoting of the tool changer as described above.

A protective hood of the machine tool is preferably opened before the pivoting of the tool changer.

By the opening of the protective hood, for example, the machine tool can be switched off.

Provision can also be made that, before the pivoting of the tool changer, a detention of the pivot arm is released. In particular, this detention is released before the rotation of the tool table.

This enables the tool changer to pivot freely.

Here a position-clamping device can be provided for the detention of the pivot arm. In this case, provision can be made that only the release as a result of the opening of the protective hood sets the position-clamping device in an active mode, and the latter can be actuated, so that a locking or detention of the tool changer in a particular position, in the present case in an operating position, can be released.

Before the pivoting of the tool changer, a tool is preferably arranged at a tool station of the tool table. This can take place in advance, for example during the ongoing operation, as described above.

In the case in which the machine tool is a crimping press, a contact strip is first removed from the crimping tool for the conversion of the tool, which in the operating state of the machine tool is located outside the protective hood. The contact coil then is taken out of the contact coil station. A paper strip coil is also removed from the paper winder. An actuation lever of a quick-release device is then actuated, and the tool is removed from the tool changer. The tool station located outside the protective hood is then empty. Thus, from this point in time onward, a new tool can be arranged on the tool changer. For this purpose, the quick-release device is also actuated and the tool is arranged on the tool changer, in the present case on the corresponding tool station. The paper coil corresponding to this tool, together with the corresponding contact coil, are inserted in the corresponding paper winder, that is to say, in the contact coil station. The tool changer is thus ready to execute the above method for the changeover of a tool. All that is required is to open the protective hood of the machine tool, to pivot the tool changer outward from the machining area, to rotate the tool table through 180°, to pivot the tool changer back into the operating position, and to close the protective hood. Here provision can be made, before closing the protective hood, for the tool to be inserted and/or clamped into a plug-in holder or a mounting of the crimping press. For this purpose, the tool is detached from the tool table by means of the quick-release device. An appropriate clamping device can be provided on the crimping press. This procedure can take place manually. However, it is also conceivable, for example, that when the tool table is swung back, the tool is inserted directly into the plug-in holder or a mounting of the crimping press.

If the crimping press and the corresponding tool within the crimping press as described above is detached from the tool table, it is necessary to first release the tool from the clamping device of the crimping press after the end of operation, with the protective hood open, and before the rotation of the tool table, to then reset it on the tool table of the tool changer, and to there clamp it by means of the quick-release device. The tool changer can then be pivoted outward. Depending on the embodiment of the tool changer, a locking device, such as a position-clamping device, must be released at the appropriate location.

Typically, a crimping press as described above has two sides. It is therefore conceivable that a second or further tool changer is arranged essentially centrosymmetrically with a first tool changer on the crimping press.

With the aid of figures, which represent only examples of embodiment, the invention is explained in more detail below. Here:

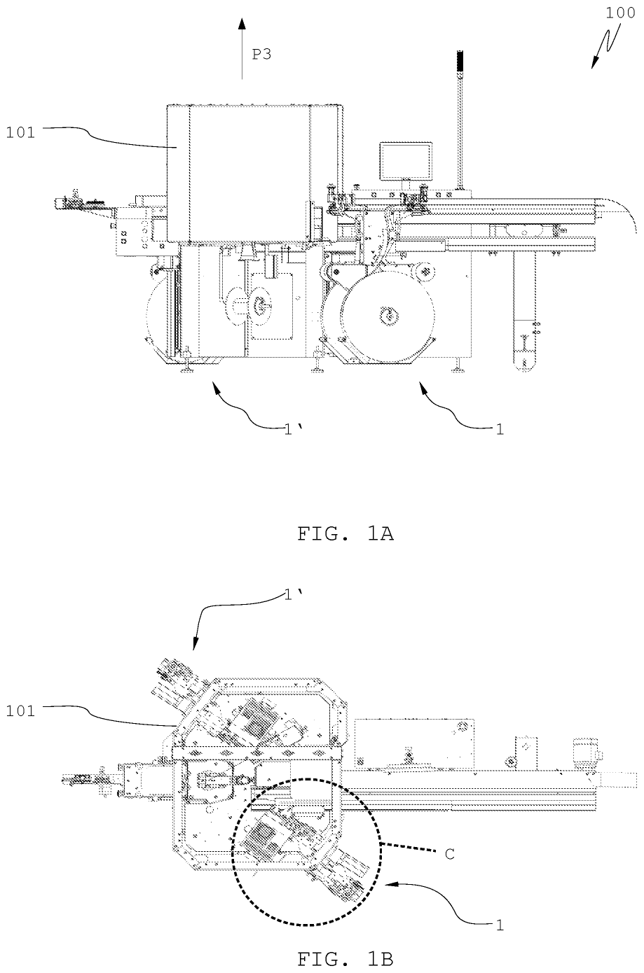

FIG. 1A: shows a machine tool

FIG. 1B: shows the machine tool of FIG. 1A in a plan view

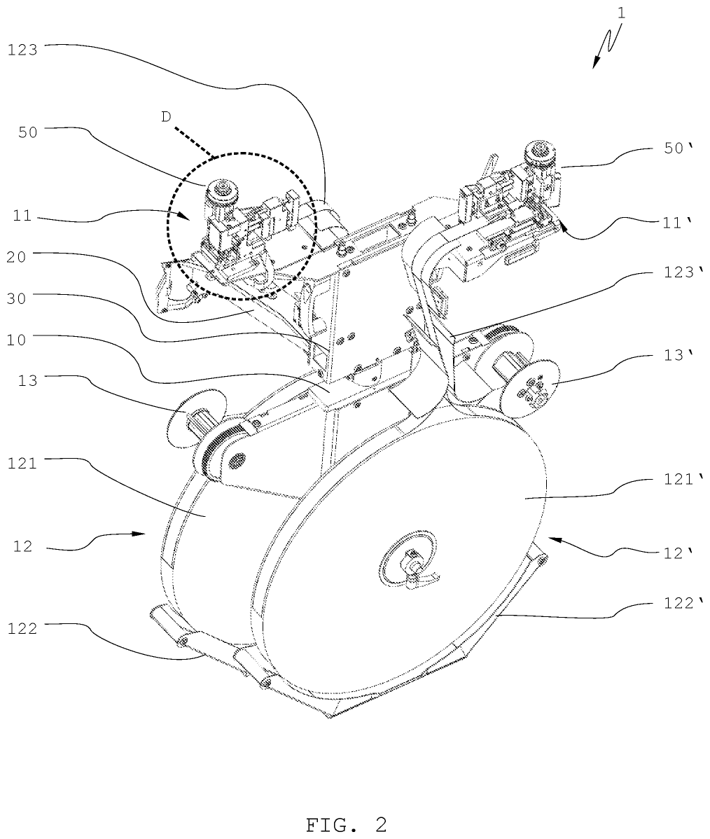

FIG. 2: shows a tool changer in perspective

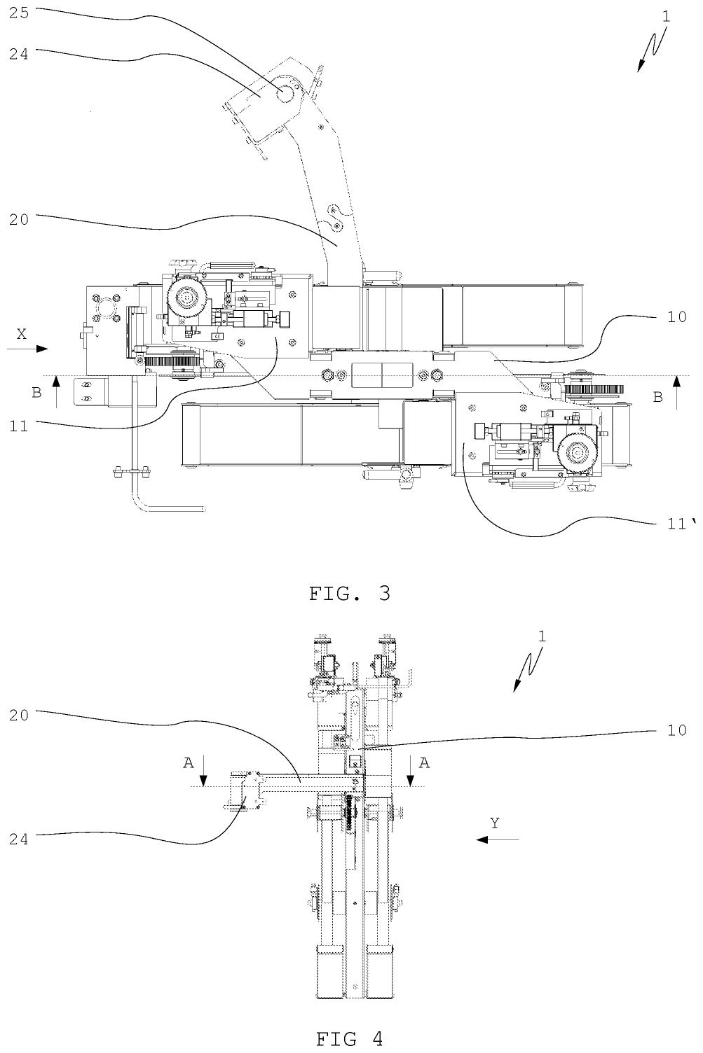

FIG. 3: shows the tool changer of FIG. 2 in a plan view

FIG. 4: shows a side view of the tool changer of FIG. 3

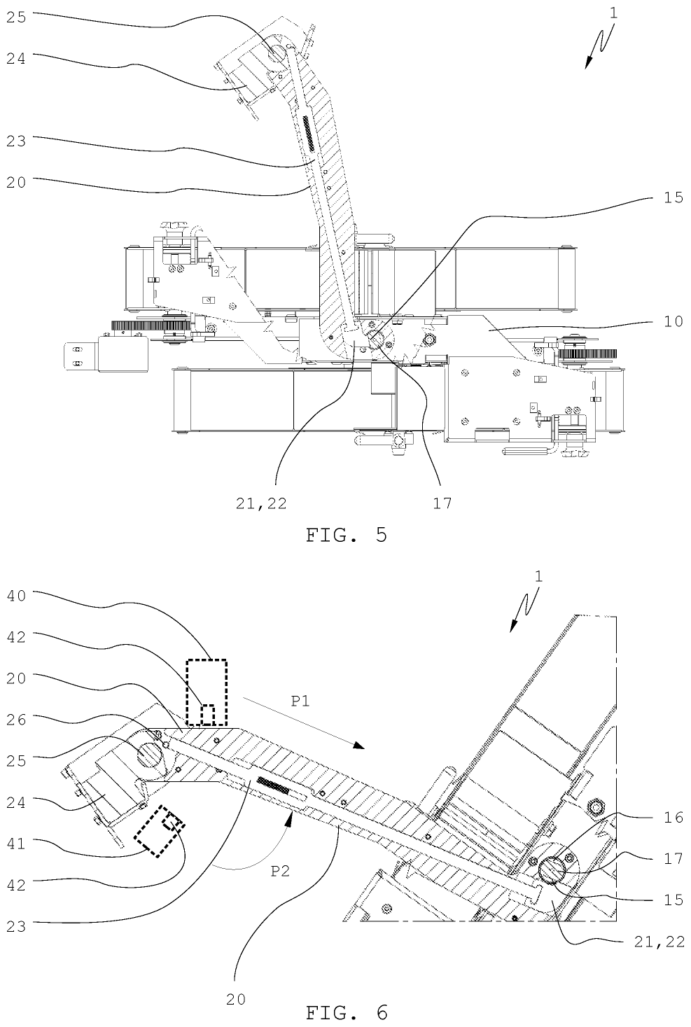

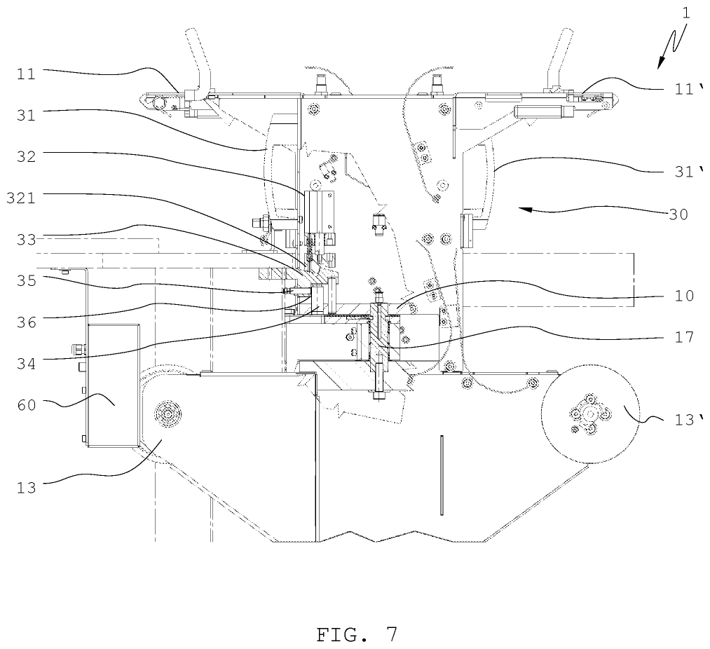

FIG. 5: shows the view in FIG. 3 in a partially sectioned representation

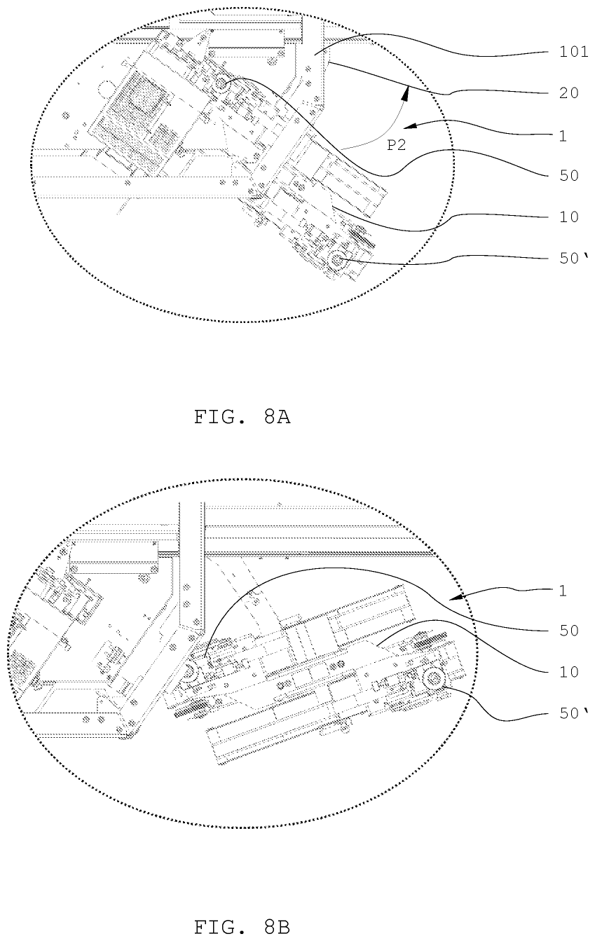

FIG. 6: shows a detail from FIG. 5 with the pivot arm in a position that is rotated relative to FIG. 5

FIG. 7: shows a detail of the view in FIG. 4 in a partially sectioned representation

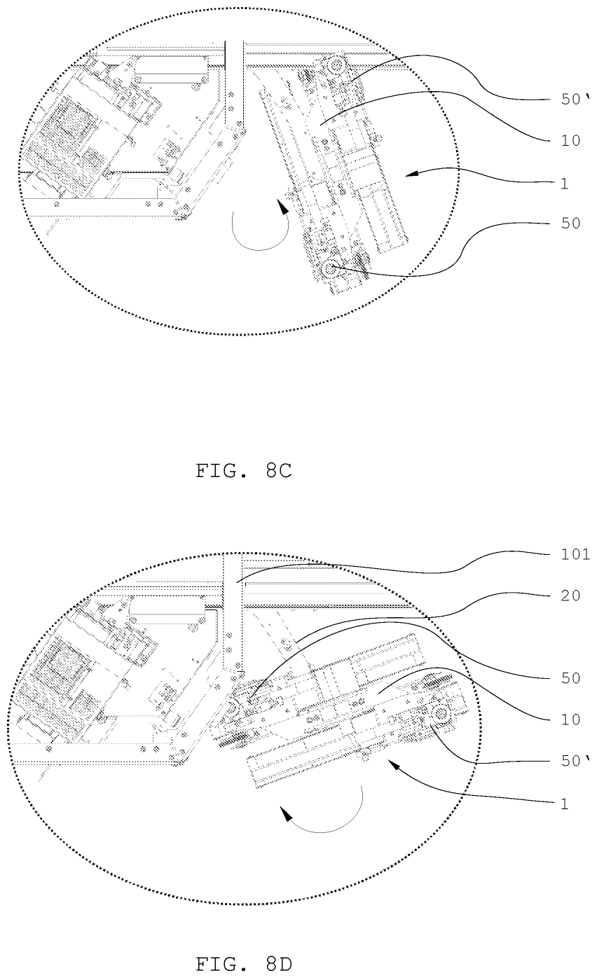

FIGS. 8A-8D: show details according to Detail C in FIG. 1B

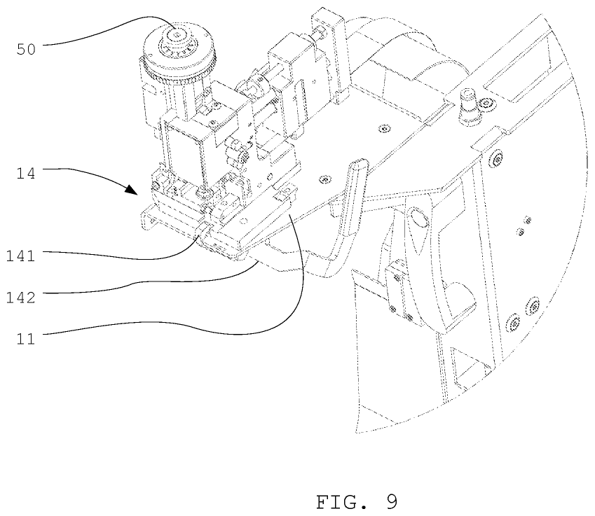

FIG. 9: shows the view according to Detail D in FIG. 2

FIG. 1A shows a machine tool 100, which in the present case is designed as a crimping press. The machine tool 100, amongst other components, has a first tool changer 1 and a second tool changer 1′. The machine tool 100 also has a protective hood 101. This can be moved in the direction of the arrow P3.

FIG. 1B shows the machine tool 100 in FIG. 1A in a plan view. The tool changers 1, 1′ are arranged essentially centrosymmetrically on the machine tool 100. The tool changers 1, 1′ are arranged such that one tool station is located inside the protective hood 101, and one tool station is located outside the protective hood 101 (see FIGS. 8A to 8D and their description).

FIG. 2 shows one tool changer 1 in perspective. The tool changer 1 has a tool table 10. The tool table 10 is mounted on a pivot arm 20 such that it can rotate. The pivot arm 20 is mounted on a mounting base 24 such that it can rotate (see FIG. 3). The tool changer 1 has a position-clamping device 30, the function of which is later explained with reference to FIG. 7.

The tool table 10 has two tool stations 11, 11′. One tool 50, 50′ is arranged at each of the respective tool stations 11, 11′. For each tool 50, 50′ the tool table 10 has a contact coil station 12, 12′, together with a paper winder 13, 13′. In each contact coil station 12, 12′ is arranged an appropriate contact coil 121, 121′. Each contact coil station 12, 12′ has a protective plate 122, 122′. The protective plates 122, 122′ prevent any inadvertent contact, for example with the floor, of a contact tape located on the respective contact coil 121, 121′. Above the respective contact coil station 12, 12′ is in each case a guide plate group, with guide plates 123, 123′ for the guidance of the contact tape into the respective tool 50, 50′.

The tools 50, 50′ are attached at the respective tool station 11, 11′ with a quick-release device 14 (see FIG. 9).

The guide plates 123, 123′ are embodied and arranged such that these extend around the pivot arm 20, that is to say, a contact tape is guided appropriately around the pivot arm 20, or around an appropriate extension of the pivot arm 20. In other words, the guide plates 123, 123′ are arranged offset relative to a longitudinal extension of the pivot arm 20. Since the guide plates 123, 123′ extend from a plane below the pivot arm 20 to a plane above the pivot arm 20, this configuration of the guide plates 123, 123′ enables the alternating rotation of the tool table 10 through +/−180°.

FIG. 3 shows the tool changer 1 in FIG. 2 in a plan view. The tool stations 11, 11′ are arranged on the tool table 10 centrosymmetrically around a pivot bolt (see FIG. 5). The tool table 10, with the pivot arm 20, is connected via a pivot bolt 25 to the mounting base 24, and is thus mounted on the mounting base 24 such that it can pivot. The mounting base 24 is connected to the machine tool 100 at an appropriate location (see FIG. 1). Thus, the tool changer 1 is mounted on the machine tool 100 such that it can pivot.

FIG. 4 shows a side view of the tool changer 1 in FIG. 3 in the arrow direction X (see FIG. 3), wherein the tool changer 1 is shown in its operating position. In the operating position, the pivot arm 20 extends in an essentially horizontal position between the mounting base 24 and the tool table 10.

FIG. 5 shows the view in FIG. 3 in a partially sectioned representation. The sectioned representation extends to the line of cut A-A in FIG. 4. In FIG. 5 it can be seen that within the pivot arm 20 is located the locking device 23, which extends through the pivot arm 20. In the present case the locking device 23 is designed as a push rod. This push rod has two end faces, wherein one of the end faces has a head, which is designed as a complementary part 21, 22. In the representation in FIG. 5 the complementary part 21, 22 is in contact with a first stop 15, which is formed on the pivot bolt 17. In the present case the first stop 15 is formed as a milled face on the pivot bolt 17, and has a plane surface. Correspondingly, the complementary part 21, 22 has a similar plane surface. These plane surfaces are operatively connected with one another. By this arrangement, a rotation of the tool table 10 is prevented, since in the present case this is firmly connected to the pivot bolt 17. The locking device 23 is held by means of a spring, not specified in any further detail, which in the present case is located in a recess of the locking device 23, held in the position shown in FIG. 5.

This prevents an inadvertent unlocking of the tool table 10.

FIG. 6 shows a detail from FIG. 5, in which the position of the pivot arm 20 is rotated relative to FIG. 5. In FIG. 6 the pivot arm 20 is pivoted relative to the mounting base 24 along the arrow P2. Within the mounting base 24, an actuation bolt 26 is arranged, which has an unalterable position relative to the mounting base 24. With its end face located opposite to the complementary part 21, 22, the locking device 23 is in contact with the actuation bolt 26. Since the locking device 23, that is to say, the end face, which is in contact with the actuation bolt 26, is arranged eccentrically with respect to the pivot bolt 25, the locking device 23 is moved, by the pivoting of the pivot arm 20 relative to the pivot arm 20, in the arrow direction P1. Here the compression spring is compressed in the recess of the locking device 23. Correspondingly, the head on the second end face of the locking device 23 also moves with the complementary part 21, 22 relative to the pivot arm 20, and releases the first end stop 15. The pivot bolt 17, and at the same time the tool table 10 (see FIG. 5), can thus be rotated, in the present case counterclockwise. Here the tool table 10 can be rotated through 180°, so that the second end stop 16 moves to the position of the first end stop 15 shown in FIG. 6. By pivoting back the pivot arm 20 against the arrow direction P2, the complementary part 21, 22 can be brought into engagement with the second end stop 16. Thus, the tool table 10 is rotated through 180° from the position shown in FIG. 5.

The position that the tool changer 1 has in FIG. 6 is called the changeover position. For the definition of this changeover position, a first end position stop 40 can, for example, be provided in the area of the mounting base 24.

A second end position stop 41 can also be provided for the definition of the operating position. The two end position stops 40, 41 in each case have a limit switch 42. This enables the transmission of the respective position, for example, to the controller of the machine tool. However, these end position stops 40, 41 for the definition of the operating position, and/or the changeover position, represent only one of the possible alternatives or combinations. A second alternative is explained below with reference to FIG. 7.

FIG. 7 shows a detailed side view in the arrow direction Y from FIG. 4. The view in FIG. 7 is partially sectioned up to the line of cut B-B in FIG. 3. In the partially sectioned view of FIG. 7, the pivot bolt 17 can be seen, which is connected to the tool table 10. The two tool stations 11, 11′ are can be rotated around a corresponding axis of rotation of the pivot bolt 17. The position-clamping device 30 is also arranged on the tool table 10. The position-clamping device 30 has two hand grips 31, 31′. The position-clamping device 30 is also built centrosymmetrically. For the sake of clarity, only one half of the position-clamping device 30 is provided with reference symbols, and is explained below. On the hand grip 31 there is located a compressed air button, which is not specified in any further detail. By pressing the compressed air button, a clamping bolt 32 is actuated, that is to say, released against a spring force. With reference to FIG. 7, this means that an engagement element 321 is moved upwards. The engagement element 321 is essentially complementary to a holding fixture 33. In the present case the holding fixture 33 is located on a console of the machine tool 100 (see FIG. 1), which is shown by dashed lines in FIG. 7. An end position stop 36 is also formed on the holding fixture 33. One or a plurality of cylindrical pins 34, which are arranged on the tool table 10, are in contact with the end stop 36 in the operating position. An end position sensor 35 is provided, which detects the correct positioning of the cylindrical pin 34 at the end position stop 36. A combination of the end stops 40, 41, in particular the embodiment from FIG. 6, together with the position-clamping device 30 as in FIG. 7 is also possible.

In FIG. 7, the drive motor 60 for driving the paper winder 13 is also shown. The drive motor 60 is also arranged on the console, shown by dashed lines, of the machine tool 100. As soon as the tool changer 1 is in the operating position, the gear of the paper winder 13, not specified in any further detail, engages with the drive motor. Thus, in the position shown in FIG. 7, the paper winder 13 can be driven.

After a pivoting and rotation of the tool table 10 (as described with reference to FIG. 6), the tool table is rotated through 180°. The paper winder, identified with the symbol 13″ in FIG. 7, then engages with the drive motor 60 and is driven accordingly.

FIGS. 8A-8D show detail views according to Detail C in FIG. 1B so as to illustrate the tool change process.

FIG. 8A shows the tool changer 1 in an operating position. One tool 50 is arranged inside the protective hood 101; one tool 50′ is arranged outside the protective hood. In FIG. 8A the tool 50 is located at the tool station 11, clamped with the quick-release device 14 (see FIG. 9). That is to say, the tool 50 has already been released from a clamping device and/or mounting of the crimping press, and held on the tool table by means of the quick-release device 14. Thus, both tools are arranged 50, 50′ on the tool table 10 of the tool changer 1. The tool 50′ has been arranged at the corresponding tool station 11′ (see FIG. 2) during the ongoing operation of the machine tool. For the changeover of the tool 50, 50′ in the machine tool 100, in a first step the protective hood 101 is moved in the arrow direction P3 (see FIG. 1A). By appropriate monitoring the machine tool 100 is secured against being switched on again. By moving the protective hood 101, the tool changer 1 is accessible. If the tool changer 1 is fitted with a position-clamping device 30 (see FIG. 7), this is unlocked in a first step. In the next step, the tool table 10, which is arranged on the pivot arm 20, is pivoted, together with the pivot arm 20, in the arrow direction P2.

FIG. 8B shows the tool changer 1 in its outward pivoted position, namely in the changeover position. By the pivoting of the tool changer 1, the detention of the tool table 10 is released (see FIGS. 5 and 6 and their description). Accordingly, the tool table can be rotated, together with the tools 50, 50′ that are located on the latter, relative to the pivot arm 20 (see FIG. 8C).

FIG. 8C shows the tool changer 1 in an intermediate position during the rotation process. The tool changer 1 is rotated counterclockwise in the direction of the arrow.

FIG. 8D shows the tool changer 1 after the rotation process for the tool table 10. The position shown in FIG. 8D corresponds to that of FIG. 8B, but with the difference that the tools 50 and 50′ have exchanged their stations. From the position in FIG. 8D the tool changer 1 can be pivoted into the position according to FIG. 8A. For the final setting-up of the present crimping press, the tool 50′, in the position shown in FIG. 8D, is lifted off from the tool table 10, and inserted into an appropriate mounting, and/or clamping device, and/or plug-in holder of the crimping press. The contact coils 121, 121′ and the paper winders 13, 13′ (see FIG. 2) remain essentially unaltered. The protective hood 101 can the be moved against the arrow direction P3 (see FIG. 1A). This means that the tool 50′ is now located inside the protective hood 101, and the tool 50 can accordingly be replaced. The replacement of the tool 50 takes place by opening the quick-release device 14 (see FIG. 9) and by the replacement of the corresponding contact coils and the corresponding paper winders.

FIG. 9 shows the view according to Detail D in FIG. 2. A tool 50 is arranged at the tool station 11. The tool 50 is held by the quick-release device 14. The quick-release device 14 has a retaining claw 141, which is actuated by the actuation lever 142. The actuation lever 142 is pre-loaded by a spring, not shown here, such that it permanently assumes the position shown in FIG. 9, even if no tool 50 is clamped at the tool station 11. By the actuation of the actuation lever 142, the retaining claw 141 is released and in the view according to FIG. 9 is moved to the left and forward. This enables the tool 50 to be removed from the tool station 11.

The list of reference symbols, as well as the technical content of the patent claims and figures, is part of the disclosure. The same reference symbols denote the same components.

### REFERENCE LIST

1 Tool changer
10 Tool table
11 Tool station
12 Contact coil station
121 Contact coils
122 Sheet metal tub
123 Guide plate
13 Paper winder
131 Paper strip
14 Quick-release device
141 Retaining claw
142 Actuation lever
15 First stop
16 Second stop
17 Pivot bolt
20 Pivot arm
21 First complementary part
22 Second complementary part
23 Locking device
24 Mounting base
25 Pivot bolt
26 Actuation bolt
30 Position-clamping device
31 Hand grip
32 Clamping bolt
321 Engagement element
33 Holding fixture
34 Cylindrical pins
35 End position sensor
36 End position stop
40 End position stop
41 End position stop
42 Limit switch
50 Tool
60 Drive motor
100 Machine tool
101 Protective hood

1. A tool changer (1, 1′) for a cabling machine tool (100), in particular for a crimping press, comprising
a tool table (10) with at least two tool stations (11, 11′), preferably precisely two tool stations (11, 11′), in particular for the releasable accommodation of a tool (50, 50′), in particular a crimping tool,
wherein
the tool changer (1, 1′) has a pivot arm (20), which can be attached to the machine tool for the pivoting of the tool table (10), and the tool table (10) can be moved along a defined path, preferably a circular path.

2. The tool changer (1, 1′) according to claim 1,
wherein
the tool table (10) is arranged on the pivot arm (20) such that the tool table (10) can rotate.

3. The tool changer (1, 1′) according to claim 1
wherein
the tool table (10) has one contact coil station (12, 12′) per tool station (11, 11′), in each case for the accommodation of a contact coil (121, 121′).

4. The tool changer (1, 1′) according to claim 1,
wherein
the tool table (10) has one paper strip winder (13, 13′) per tool station (11, 11′) for winding on of paper strips (131, 131′).

5. The tool changer (1, 1′) according to claim 1,
wherein
each tool station (11, 11′) is assigned a quick-release device (14, 14′) for the attachment of the tool (50, 50′).

6. The tool changer (1, 1′) according to claim 5,
wherein
the quick-release device (14, 14′) has a retaining claw (141, 141′), and has an actuation lever (142, 142′) for the actuation of the retaining claw (141, 141′), and the retaining claw (141, 141′) preferably has at least one spring (143, 143′) €) for the pre-loading of the retaining claw (141, 141′).

7. The tool changer (1, 1′) according to claim 1,
wherein
the tool changer (1, 1′) on the tool table (10) has a first end stop (15) which interacts with a first complementary part (21) on the pivot arm (20), such that the tool table (10) assumes a first position defined relative to the pivot arm (20).

8. The tool changer (1, 1′) according to claim 1,
wherein
the tool changer (1, 1′) has a locking device (23) for the detention of the tool table (10).

9. The tool changer (1, 1′) according to claim 8,
wherein
the locking device (23) is arranged on, the pivot arm (20), and the detention of the tool table (10) is preferably dependent on a position of the pivot arm (20).

10. The tool changer (1, 1′) according to claim 1,
wherein
the pivot arm (20) has a mounting base (24) for the attachment of the tool changer (1, 1′) to the machine tool (100), wherein the pivot arm (20) is preferably connected to the mounting base (24) such that it can pivot.

11. The tool changer (1, 1′) according to claim 10,
wherein
the locking device (23) interacts with the mounting base (24) such that a release of the detention of the tool table (10) is dependent on an angle of pivot between the mounting base (24) and the pivot arm (20).

12. The tool changer (1, 1′) according to claim 1,
wherein
the pivot arm (20) can be pivoted for the pivoting of the tool table (10) into at least one operating position and one changeover position, and the tool changer (1, 1′) has an end position stop (40, 41), for the operating position, and/or for the changeover position.

13. The tool changer (1, 1′) according to claim 12,
wherein
the tool changer (1, 1′) has a position-clamping device (30) for the detention of the pivot arm (10) in at least the operating position, and/or the changeover position.

14. The tool changer (1, 1′) according to claim 13,
wherein
the position-clamping device (30) has a holding fixture (33) for the detention of the tool changer (1, 1′) in the operating position, which holding fixture (33) is arranged, or can be arranged, on the machine tool (100), and/or the position-clamping device (30) has an end position stop (36) for the operating position.

15. A machine tool, in particular a cabling machine tool (100), preferably a crimping press, comprising at least one, preferably two, tool changers, in particular a tool changer (1, 1′) according to claim 1, wherein the tool changer (1, 1′) comprises a pivot arm (20) for the pivoting of a tool table (10), and the pivot arm (20) is arranged on the machine tool (100) such that it can pivot, and the tool table (10) can be moved along a defined path, preferably a circular path.

16. The machine tool according to claim 15 comprising a protective hood (101),
wherein
a tool table (10) is arranged on the pivot arm (20), wherein the tool table (10) has at least two tool stations (11, 11′), and in an operating state of the machine tool at least one tool station (11, 11′) is arranged inside the protective hood (101) and one tool station (11, 11′) is arranged outside the protective hood (101).

17. The machine tool according to claim 15,
wherein
at least one or a plurality of limit switches (42) are provided for the monitoring of at least one of the parameters from the following group:
position of the pivot arm (20)
position of the protective hood (101)
position of the tool (50, 50′)
status of the position-clamping device (30)
occupation of the tool station (11, 11′).

18. A method for the changing of a tool (50, 50′) of a machine tool, in particular a cabling machine tool (100), preferably a crimping press, in particular a machine tool according to claim 15,
wherein the machine tool comprises a tool changer (1, 1′), which comprises a tool table (10) and a pivot arm (20) for the pivoting of the tool table (10) along a defined path, preferably a circular path comprising the steps:
rotation of the tool table (10) from a first position into a second position, wherein
the tool changer (1, 1′), before the rotation, is pivoted from an operating position into a changeover position.

19. The method according to claim 18,
wherein
a protective hood (101) of the machine tool is opened before the pivoting of the tool changer (1, 1′).

20. The method according to claim 18,
wherein
before the pivoting of the tool changer (1, 1′) a detention of the pivot arm (20) is released, before the rotation of the tool table (10) a detention of the tool table (10) is released.

21. The method according to one of the claim 18,
wherein
before the pivoting of the tool changer (1, 1′), a tool (50, 50′) is arranged at a tool station (11, 11′) of the tool table (10).
